(19) United States
(12) Patent Application Publication
(10) Pub. No.: US 2008/0140235 A1
(43) Pub. Date: Jun. 12, 2008

(54) EQUALIZATION APPLICATION BASED ON AUTONOMOUS ENVIRONMENT SENSING

(76) Inventor: James G. McLean, Fuquay-Varina, NC (US)

Correspondence Address: HOFFMAN WARNICK & DALESSANDRO LLC, 75 STATE ST, 14TH FLOOR, ALBANY, NY, 12207, US

(21) Appl. No.: 11/567,752

(22) Filed: Dec. 7, 2006

(51) Int. Cl. G06F 17/00

(52) U.S. Cl. 700/94

(57) ABSTRACT

The invention is directed to both a method of, and system for, applying equalizations based on autonomous environment sensing. A method in accordance with the present invention includes providing a multimedia repository device, wherein the device further includes a environment detection means; operatively utilizing the multimedia repository device in conjunction with at least one external playback device; and modifying at least one setting of one of the at least one external playback device and the multimedia repository device, based on the detected environment. The system includes a multimedia repository device, that includes at least one of an audio source and a video source; at least one external playback device in communication with the multimedia repository device; and an environment detection means connected to at least one of the external playback device and the multimedia repository device, configured to autonomously detect an environment, further wherein the multimedia repository device applies a setting based on the detected environment.

### BACKGROUND OF THE INVENTION

1. Field of the Invention

The present invention generally relates to multimedia repository devices and playback devices and the environment in which these devices are played. More specifically, the present invention is directed to a method of applying equalization based on autonomous environment sensing.

2. Related Art

Depending on where and how multimedia content is being utilized, it may benefit from application of various equalization, audio, and/or visual modification techniques. For example, music listened to in a car may sound better with dynamic range compression enabled (e.g., allowing softer passages to be heard over background noise), while the same effect might detract from the music in a home or headphone listening environment. Similarly, loudness contour and other tone modifications may be appropriate in one listening environment but not in another. Various solutions have been attempted for this problem, such as allowing a user to manually adjust tone controls on a portable player or the allowing the user to select such features when copying music to a CD or when dumping it to an MP3 player. These techniques have significant limitations because they require concerted effort by the user and, as such, are intrusive. Further, once such settings are applied, they limit the optimal playback of the music to the single environment targets. Many users prefer not to bother with such available settings and, as such, their music experience is sub-optimal in most environments.

Accordingly, a need exists for an improvement in the art of applying modifications in the environments in which the multimedia repository device is played that overcomes at least one of the aforementioned deficiencies in the art.

### SUMMARY OF THE INVENTION

The present invention is directed to an application of equalization based on autonomous environment sensing.

A first aspect of the present invention is directed to a method comprising: providing a multimedia repository device, wherein the device further includes a environment detection means; operatively utilizing the multimedia repository device in conjunction with at least one external playback device; and modifying at least one setting of one of the at least one external playback device and the multimedia repository device, based on the detected environment.

A second aspect of the present invention is directed to a system comprising: a multimedia repository device, that includes at least one of an audio source and a video source; at least one external playback device in communication with the multimedia repository device; and an environment detection means connected to at least one of the external playback device and the multimedia repository device, configured to autonomously detect an environment, further wherein the multimedia repository device applies a setting based on the detected environment.

The illustrative aspects of the present invention are designed to solve the problems herein described and other problems not discussed.

### BRIEF DESCRIPTION OF THE DRAWINGS

These and other features of this invention will be more readily understood from the following detailed description of the various aspects of the invention taken in conjunction with the accompanying drawings in which:

FIG. 1 depicts a multimedia repository device applying an equalization based on autonomous environment sensing in accordance with an embodiment of the present invention.

FIG. 2 depicts a schematic representation of a method of applying equalization based on autonomous environment sensing in accordance with an embodiment of the present invention.

The drawings are merely schematic representations, not intended to portray specific parameters of the invention. The drawings are intended to depict only typical embodiments of the invention, and therefore should not be considered as limiting the scope of the invention. In the drawings, like numbering represents like elements.

### DETAILED DESCRIPTION OF THE INVENTION

As detailed above, the present invention is directed to both a method of, and system for, applying equalizations based on autonomous environment sensing.

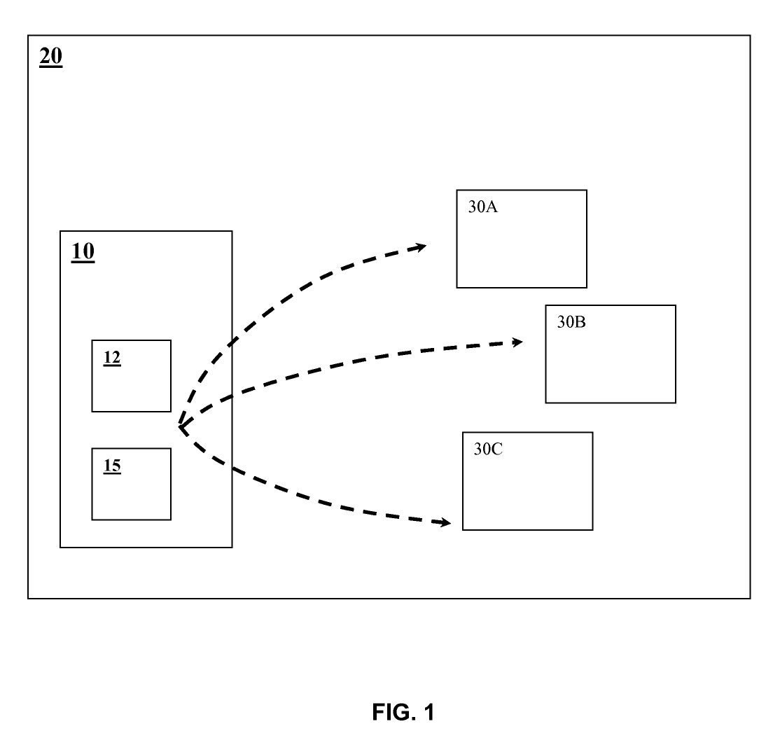

An audio repository device applying an equalization based on autonomous environment sensing in accordance with an embodiment of the present invention is depicted in FIG. 1. FIG. 1 depicts a media storage/distribution, or multimedia repository, device (e.g., “player”) 10 which is in use in an environment 20. The player 10 may include an audio source 12 (i.e., “music source”) and/or a video source 15. The player 10 is used in conjunction with, and is operatively attached to, at least one an external playback device 30, such as an audio amplification and speaker system 30A, a personal listening device 30B, and a visual display 30C. The external playback device 30 may be of any suitable size or type ranging from micro-headphones to a theater.

The player 10 may include mechanisms for storing and choosing media selections, a mechanism for routing media selections to external playback devices 30 (such as but not limited to 30A, 30B, 30C) and one or more functions allowing one or more alterations of the nature of the media played such as equalization circuit(s), tone controls, audio compression circuits, audio limiting circuits, video aspect ratio controls, video resolution controls, video color enhancement, contract enhancement, and/or brightness enhancement circuitry. The player 10 may also contain more than one version of a given selection (for example may contain both a stereo and 5.1 channel audio version of a musical track) or may include the capability to re-format and output selections in more than one media format (such as standard and high-definition video signals).

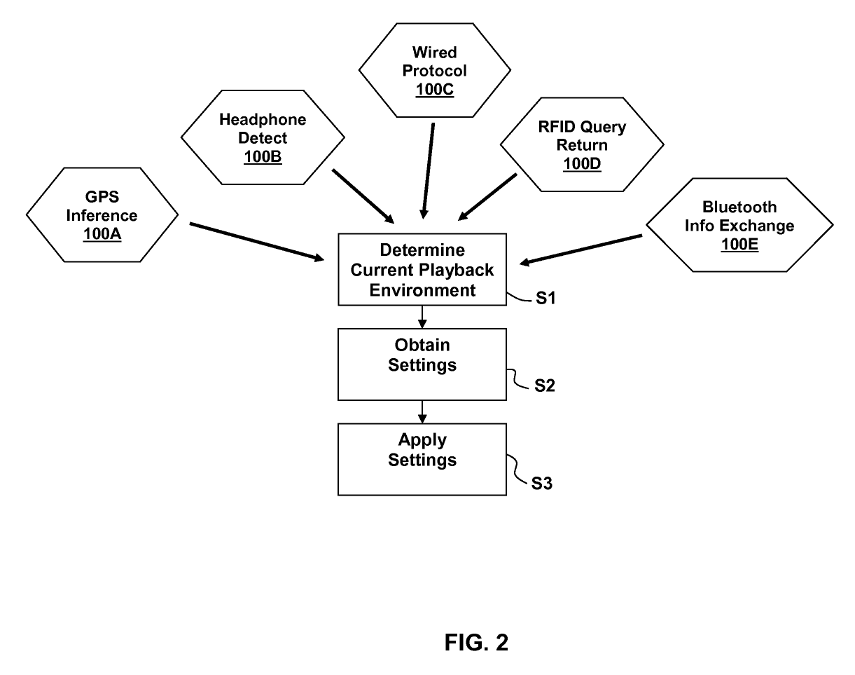

FIG. 2 depicts a schematic representation of a method of applying equalization based on autonomous environment sensing in accordance with an embodiment of the present invention. Viewing FIG. 1 and FIG. 2 together, the method includes process S1, wherein the current playback environment is determined. Process S2 follows which includes obtaining settings. Process S3 follows and includes applying settings that were obtained in process S2.

The player 10 and/or the external playback device 30 include at least one environment detection means 100. The environment detection means 100 may be autonomous, which includes having a functionality that allows the environment detection means 100 to act automatically and/or independently and without the need for any user activation and/or interaction. The environment detection means 100 may, for example, include use of Global Positioning System (GPS) data 100A (i.e., “GPS Inference”), use of a headphone presence detection method 100B (i.e., “Headphone Detect”), use of a signal protocol over a wired connection 100C (i.e., “Wired Protocol”), use of an Radio Frequency Identification (RFID) query and returned data interpretation 100D (i.e., “RFID Query Return”), and/or exchange and interpretation of data via Bluetooth or other wireless protocol 100E (i.e., “Bluetooth Info Exchange”), or any other known method for environment detection information exchange.

GPS inference 100A may include a GPS detection means that determines the exact physical location of the external playback device 30 in the environment 20. Based on the determined physical location, applicable settings may be applied to the player 10. The determined physical location may be compared to known physical locations. Thus, for example, if the determined physical location is the user's home theater, applicable settings may include selection of a 5.1-channel audio track. The determined physical location may be more generally assessed based on known geography. Thus, for example, if the determined physical location is an urban area, applicable settings may include a higher bass setting. Additionally, the rate of change of the physical location may be determined by the GPS inference 100A. In this manner, the velocity of the environment 20 that the player 10 and/or external playback device 30 may be calculated and applicable settings be applied accordingly. For example, a threshold of 4 m.p.h. could be set wherein the velocity is that of a person jogging. Thus, upon a detection of the 4 m.p.h. velocity, a compressed format and/or particular equalization setting more suited for a mobile playing device 10 may be applied. Contrastingly, if the velocity is determined to be over, for example, 20 m.p.h. (e.g., in a vehicle), then a setting such as audio equalization profile suitable for automobiles is applied.

Headphone detect 100B may include means for detecting and determining if, and what type, of personal playback mechanism, such as headphones, earbuds, or portable speakers are being used as the external playback device 30. Thus, when the external playback device 30 is a headphone set, the appropriate and applicable equalization setting is applied to the player 10. Multiple types of headphones may be defined and identified using this method. Thus, for example, the player 10 may differentiate between high-quality audiophile headphones and low-cost earbuds and apply appropriate audio settings for each possible case.

Wired protocol 100C may include communication between the player 10 and the external playback device 30, wherein the external playback device 30 “tells” the player 10 what specific type the external playback device 30 that is communicating is. For example, the communication may be such that the external playback device 30 communicates to the player 10 that it (30) is a vehicle stereo. As a result, the player 10 will adjust the setting(s) of the particular music source 12 so that when the music source 12 is sent to the external playback device 30 (i.e., vehicle stereo) for playing, the settings are optimal for that particular environment 20, which include the external playback device 30. Further, the player 10 upon detecting or sensing that the particular external playback device 30 is a vehicle stereo within a vehicle, then can look up specific settings for that particular vehicle, vehicle type, vehicle driver, and/or the like.

RFID query return 100D may include using RFID technologies to mark the environment 20. For example, the player 10 may include a plurality of RFID “tags” (not shown) that may be placed in a variety of playback locations within different environment(s) 20. Upon suitable setup, the various RFID tags can connote different environments 20 and their concomitant settings for the player 10. For example, a particular RFID tag would be placed beneath a car dashboard. The player 10 may include a RFID detection means for detecting the location and type of RFID tag that is proximate thereto. Thus, in the example, when the player 10 is located in the vehicle the player 10 will detect the RFID tag located beneath the dashboard. In this manner, the player 10 will then “know” that its instant environment 20 includes a vehicle and a vehicle stereo 30 and be able to make the appropriate adjustments to settings based on this environment 20 detection.

Bluetooth info exchange 100E may include similar functionalities as the wired protocol 100C but in a wireless environ.

In process S1 the player 10 uses the environment detection information gathered through one, or more, of these means to determine a current playback environment of the player 10 and/or the external playback device 30.

In process S2, once the player 10 has identified the environment, the player 10 determines the appropriate playback settings for that environment by means of, for example, a lookup table. The lookup table may include for example settings for one, or more, of the following: compression setting; bass boost setting; equalization setting; video output setting; audio limiting circuits, video aspect ratio setting; video resolution control setting; video color enhancement setting; video contrast enhancement setting; video brightness enhancement setting; sound file type selection; video file type selection; and/or the like. Possible settings may be discrete or variable along a continuum. For example, compression setting may be adjusted between off, low, medium, and high, or may be assigned an arbitrary numerical value along a continuum of possible settings (e.g., a compression setting of 0-100). Bass boost setting may be adjusted between off, low, medium, and high, or may be assigned an arbitrary numerical value along a continuum of possible settings (e.g., a bass-boost setting of 0-100). Equalization setting may be adjusted between flat, and various contours. These settings are described as examples only, the scope of the invention includes any and all possible modifications of the video, audio, or other media signals provided by the multimedia repository 10.

One, or more, of the settings are then applied to the functions controlling the audio and/or video output of the player 10 in process S3.

In an alternative embodiment, the information transmitted to the player 10 is in the form of direct instructions as to the proper output settings for the player 10 from at least one of the external playback device(s) 30. In other words, rather than a process by which the player 10 determines it is in a car environment, for example, and deduces that a compression circuit should be activated, the player 10 receives direct instruction to turn on a compression circuit from the associated external playback device 30 (e.g., car stereo).

The foregoing description of the embodiments of this invention has been presented for purposes of illustration and description. It is not intended to be exhaustive or to limit the invention to the precise form disclosed, and many modifications and variations are possible.

What is claimed is:

1. A method comprising:
providing a multimedia repository device, wherein the device further includes a environment detection means;
operatively utilizing the multimedia repository device in conjunction with at least one external playback device; and
modifying at least one setting of one of the at least one external playback device and the multimedia repository device, based on the detected environment.

2. The method of claim 1, wherein the environment detection means is autonomous.

3. The method of claim 1, wherein the at least one external playback device is selected from a group consisting of: headphones, earbuds, self-powered audio speakers, a vehicle stereo, a mobile video system, a videogame, a video display, a home theater, a public address system, and a public display system.

4. The method of claim 1, wherein the environment detection means is embedded in one of: a music source or the multimedia repository device.

5. The method of claim 1, wherein the environment is at least one of an actual location of the external playback device or an ID signal from the multimedia repository device.

6. The method of claim 1, wherein the at least one setting is one selected from a group consisting of: a compression setting; a bass boost setting; an equalization setting; a video output setting; an audio limiting circuit setting, a video aspect ratio setting; a video resolution control setting; a video color enhancement setting; a video contrast enhancement setting; a video brightness enhancement setting; a sound file type selection; and a video file type selection.

7. A system comprising:
a multimedia repository device, that includes at least one of an audio source and a video source;
at least one external playback device in communication with the multimedia repository device; and
an environment detection means connected to at least one of the external playback device and the multimedia repository device, configured to autonomously detect an environment, further wherein the multimedia repository device applies a setting based on the detected environment.
